(19) United States
(12) Patent Application Publication
(10) Pub. No.: US 2005/0148304 A1
(43) Pub. Date: Jul. 7, 2005

(54) Calibration method for the correction of in-phase quadrature signal mismatch in a radio frequency transceiver

(75) Inventor: Albert Chia-Wen Jerng, Cambridge, MA (US)

Correspondence Address: C. P. Chang;c/o Pacific Law Group LLP, Suite 525, 224 Airport Parkway, San Jose, CA, 95110, US

(73) Assignee: Fodus Communications, Inc., Sunnyvale, CA (US)

(21) Appl. No.: 10/746,586

(22) Filed: Dec. 24, 2003

(51) Int. Cl. H04B 1/40; H04B 1/44; H04B 1/10

(52) U.S. Cl. 455/75; 455/78; 455/295

(57) ABSTRACT

A method is disclosed to correct the IQ mismatch of an RF transceiver. The method generates a reference signal down a transmitting-receiving loop and measures the received signals S_{DTA-1} and S_{DTA-2}, respectively dominated by their desired component and image component, under two programmed mixer settings of operating mode and LOF. The method then calculates a system image rejection ratio (IRR_{sys}) with S_{DTA-1} and S_{DTA-2}, systematically adjusts the amplitude and phase pre-distortion of the transmitting baseband signals till IRR_{sys} is maximized thus correcting for the transmitter IQ mismatch. The now-corrected transmitter IQ mismatch is then used to correct receiver IQ mismatch by reprogramming the first setting and measuring mismatches in amplitude ΔA and phase Δφ between received baseband IQ signals, corrects for ΔA and Δφ accordingly and stores the corrective values for future compensation of receiver IQ mismatch. The systematic pre-distortion can be implemented using a look-up table or analytical calculation.

### CROSS REFERENCE TO RELATED APPLICATIONS

This application is related to the U.S. patent application Ser. No. 10/447,810, filed 05/28/2003, entitled “Wireless LAN receiver with packet level automatic gain control” by Steve S. Yang, assigned to the same assignee, which is herein incorporated by reference.

### FIELD OF THE INVENTION

The present invention relates generally to the field of wireless communication. More particularity, the present invention concerns the calibration of a radio frequency (RF) transceiver.

### BACKGROUND OF THE INVENTION

RF transceivers for wireless LAN systems generally use complex digital modulation schemes in order to achieve high data rates with limited bandwidth. Some examples are BPSK, 4-QPSK, 8-PSK, 16-PSK, 8-QAM, 16-QAM and 64-QAM. QAM, or quadrature amplitude modulation, is one such efficient digital modulation scheme. With QAM, data symbols are mapped into baseband in-phase (I) and quadrature (Q) modulated component signals. To facilitate visualization, the amplitude and phase angle of each of the baseband I and Q component signals can be expressed within an x-y Cartesian coordinate system wherein amplitude=(x²+y²)^{1/2s} and phase=tan⁻¹(y/x). In practice, a circuit known as an IQ modulator is used to transform and up-convert bit streams representing the baseband I and Q components into to an RF carrier frequency for radio transmission. The IQ modulator is implemented using a mixer with a local oscillator (LO).

As a general remark before further description, mixers are used for converting an RF signal from one frequency to another frequency for further signal filtering and amplification. The mixer is a nonlinear device. That is, during the frequency conversion process, the mixer not only generates a desired frequency but also simultaneously generates another unwanted frequency. For example, given a local oscillator frequency (LOF) of fa being mixed with a signal frequency of fb during an up conversion process, the mixer generates a desired output frequency at (fa+fb) and another unwanted output frequency at (fa−fb). The output component at frequency (fa+fb), being higher than the LOF fa, is called the upper sideband, and the output component at frequency (fa−fb), being lower than the LOF fa, is called the lower sideband. A filter is thus required to remove the unwanted lower sideband. For another example, when one converts a signal at frequency fb to frequency (fa+fb), a signal at frequency (2fa+fb) also gets converted to (fa+fb) as (2fa+fb)−fb=(fa+fb). For those skilled in the art, the signal (2fa+fb) is called an image of the signal fb.

Returning to the description of the IQ modulator, it is implemented using a single-sideband mixer that requires as inputs the baseband I and Q bit streams and quadrature phases of an RF local oscillator (LO) signal. Ideally, the in-phase and quadrature components, of both the baseband signal and the LO, are matched in amplitude and in exact quadrature relationship in phase. In practice, a variety of unavoidable circuit hardware tolerances exist resulting in a corresponding amplitude and phase mismatch. Such amplitude and phase mismatches are known as IQ mismatches in the art and cause the constellation point of a data symbol to deviate from its ideal location. This is illustrated in FIG. 1 that shows a typical constellation under the 4-QPSK modulation scheme. The ideal symbols and their respective locations are symbol 1 at (1,1), symbol 2 at (−1,1), symbol 3 at (−1,−1) and symbol 4 at (1,−1). The corresponding actual symbols, 1′, 2′, 3′ and 4′ are skewed from their ideal locations due to various tolerances in the RF transceiver such as IQ mismatches. As a result, the modulated signals are made more difficult to accurately detect in the presence of noise. The symbol error rate of the receiver portion will increase and degrade the overall RF transceiver performance.

IQ mismatches in the LO signals are common due to the difficulty of precisely matching amplitude and phase of high frequency RF signals on integrated circuits (IC). A common metric used in the art to characterize the degree of IQ mismatch is referred to as the image rejection ratio (IRR). For example, an up-converting mixer modulates the LO signal to produce both an upper sideband (USB) and a lower sideband (LSB). If the LOF is f₁and the input signal frequency to the mixer is f₂, then a single-sideband mixer will produce a USB at frequency f₁+f₂ and an LSB at frequency f₁−f₂. If the desired sideband is at f₁+f₂, then the f₁−f₂ signal is referred to as the image signal. In an ideal single-sideband mixer, the image sideband is completely nulled from the mixer output. However, when IQ mismatches are present, there is only a finite rejection of the image sideband and this rejection is quantified as the IRR:
image rejection ratio (IRR)=20×log₁₀(desired sideband/image sideband) (1)
A typical IQ mixer with a +/−3° phase error and +/−2% amplitude error will exhibit an IRR of about 25 dB, meaning that the image signal level is about 25 dB lower than that of the desired signal. Within an IEEE 802.11 standard for Wireless Local Area Network (WLAN), the 64-QAM modulation scheme is desired to produce an IRR of 35 dB or greater. Generally, the highest data transmission rate is achieved when as many digital data symbols as possible are placed in a constellation. Under the IEEE 802.11, the modulation scheme with the highest data rate is 64-QAM, meaning there are 64 constellation points. As the separation between neighboring constellation points becomes very small, the placement accuracy for each constellation point becomes highly stringent. Hence this translates into a requirement of high IRR and correspondingly small amount of tolerable IQ mismatch. Quantitatively, system considerations demand an approximate IRR of 35 dB for 64-QAM. Notwithstanding this demand, achieving greater than the minimum required IRR is desirable as it relaxes other transceiver specifications such as signal distortion and phase noise.

While circuit techniques exist to mix or separate quadrature components of an RF signal, finite degree of matching of IC components, parameter variations over temperature and from IC processing and unavoidable imperfections such as parasitics from physical layout prevent the achievement of perfect IQ matching. Often times, the actual value of achievable IRR cannot be predicted or is not known until after the IC has been fabricated and characterized. Thus, there is a need to find a way to reduce IQ mismatches from an RF transceiver after the circuit has been designed and fabricated.

One traditional approach to reducing IQ mismatches is to measure the actual phase and amplitude errors of the RF LO signal using amplitude and phase detector circuits. The detector circuits can be embedded in a correction loop using gain and phase adjustment circuits. In practice, this approach is difficult to implement as the detector circuits operate at high frequencies and are themselves sensitive to various circuit parameter mismatches and process variations. Additionally, precise gain and phase adjustment circuits are difficult to realize at high frequencies.

A second approach to reducing IQ mismatches in a receiver mixer uses a least mean square (LMS) algorithm to null the response of the mixer to an image signal. The LMS algorithm updates variable gain and phase circuits that correct for IQ mismatches along the LO path until the image response has been minimized. Once again, a high degree of circuit complexity is required to implement this solution and it will still be sensitive to unavoidable imperfections such as circuit parameter mismatches, DC offsets and process variations.

A third approach is to measure the IQ mismatch from a transmitter and correct it at the baseband inputs by using digital predistortion. Digital predistortion has an advantage in that it is precisely controlled in the digital domain hence avoiding various analog mismatches and variations. However, the key obstacle to this approach is the formulation of a method by which to accurately measure the IQ mismatch. Directly measuring IQ mismatch is difficult to do in high frequency analog circuits. Likewise, indirectly measuring IQ mismatch through the metric of IRR is also difficult as this requires an ideal demodulator that is essentially free of IQ mismatches and does not degrade the IRR itself. While sophisticated test and measurement equipment can function as an ideal demodulator, the requirement here is for the RF transceiver IC itself to automatically calibrate and correct for the IQ mismatch. Unfortunately, the receiver circuit of the IC itself can not be an ideal demodulator and will exhibit the same finite image rejection ratio as that of the transmitter thus making it difficult to get an accurate measurement of the IRR of the transmitter only. Therefore, a method is needed by which one can accurately measure the IRR of the transmitter while using non-ideal receiver components of the IC.

### SUMMARY OF THE INVENTION

A calibration method for the correction of IQ mismatch of a radio frequency (RF) transceiver (RFXVR) with digital signal processing. The method generates a reference signal S_{REF} down a temporarily closed transmitting-receiving loop and measures a correspondingly received data signal S_{DTA} under two programmed mixer settings of operating mode and LOF:
(a) A first setting so as to yield a first S_{DTA-1} whose signal power is essentially dominated by that of its desired component signal S_{DSR-1}.
(b) A second setting so as to yield a second S_{DTA-2} whose signal power is essentially dominated by that of its undesirable image signal S_{IMG-2}.
   The method then calculates a system image rejection ratio (IRR_{sys}) with S_{DTA-1} and S_{DTA-2}, systematically adjusts the amplitude and phase pre-distortion of the transmitting baseband signals till IRR_{sys} is maximized thereby correcting for the transmitter IQ mismatch. On an equivalent basis, a simple ratio k=S_{DTA-1}/S_{DTA-2} can alternatively be maximized to achieve the same result. The method then uses the now-corrected transmitter IQ mismatch to correct receiver IQ mismatch as follows:
(c) Reprograms the first setting.
(d) Measures mismatches in amplitude ΔA and phase Δφ between correspondingly received baseband IQ signals, corrects for ΔA and Δφ accordingly and stores the corrective values for future compensation of receiver IQ mismatch.
   The above systematic adjustment of the pre-distortion can be implemented using a look-up table, analytical calculation or any other technically equivalent method. In practice, the method can be performed at system power on or periodically during an idle time of the RFXVR to maintain accuracy over time.

Additional advantages, together with the foregoing, are attained in the exercise of the invention in the following description and resulting in the embodiment illustrated in the accompanying drawings.

### BRIEF DESCRIPTION OF THE DRAWINGS

The current invention will be better understood when consideration is given to the following detailed description of the preferred embodiments. For clarity of explanation, the detailed description further makes reference to the attached drawings herein:

FIG. 1 shows a typical constellation of IQ mismatches under a 4-QPSK scheme;

FIG. 2 is a simplified block diagram of an RF transceiver (RFXVR) for the illustration of the calibration method of the present invention for the correction of IQ mismatch in the RFXVR;

FIG. 3 shows a top-level flow chart of one embodiment of the present invention for IQ-calibration of the transmitting mixer of the RFXVR;

FIG. 4 is the simplified RFXVR block diagram with annotations of certain operating parameters for the illustration of the first part of the calibration method for the calibration and correction of IQ mismatches from the transmitting mixer of the RFXVR; and

FIG. 5 is the simplified RFXVR block diagram with annotations of certain operating parameters for the illustration of the second part of the calibration method for the calibration and correction of IQ mismatches from the receiving mixer of the RFXVR.

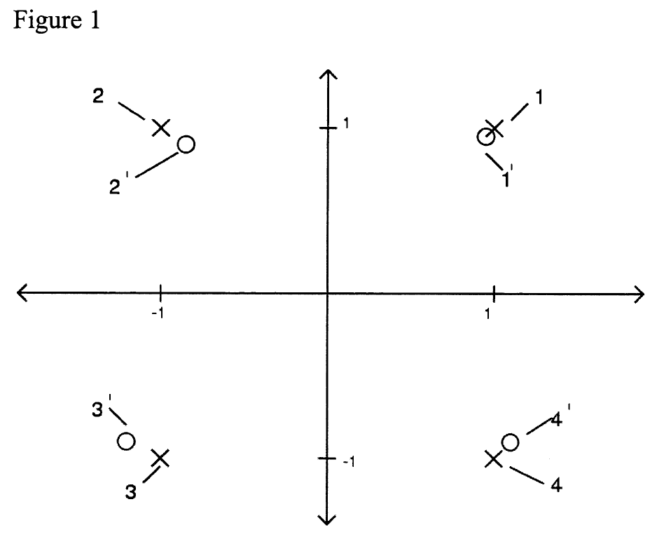

### Glossary

ADC: Analog to Digital Converter
BPR: band pass rejection
DAC: Digital to Analog Converter
DSP: digital signal processor
IF: Intermediate Frequency
I/Q: In-phase/Quadrature
IRR: image rejection ratio
LAN: Local Area Network
LMS: least mean square
LO: Local Oscillator
LOF: Local Oscillator Frequency
LSB: lower sideband
QAM: quadrature amplitude modulation
RF: Radio Frequency
RFXVR: RF transceiver
SAW: surface acoustic wave
USB: upper sideband
WLAN: Wireless Local Area Network

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention. The detailed description is presented largely in terms of flow charts, logic blocks and other symbolic representations that directly or indirectly resemble the operations of signal processing devices coupled to networks. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

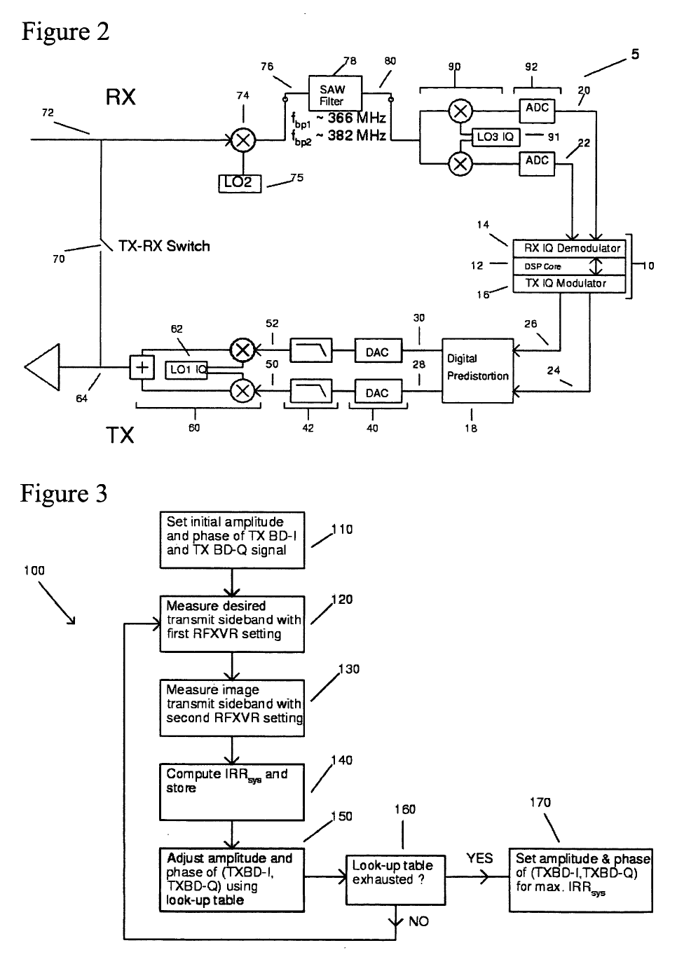

FIG. 2 is a simplified block diagram of an RF transceiver (RFXVR) 5 for the illustration of the calibration method of the present invention for the correction of IQ mismatch in the RFXVR. The various components along a transmitting signal path of the RFXVR 5 are described below.

A digital signal processor (DSP) 10 that in turn includes a DSP core 12, an RX IQ demodulator 14, a TX IQ modulator 16 and a digital pre-distortion 18. The RX IQ demodulator 14 functions to demodulate a receiving baseband digital in-phase signal (RX BD-I signal 20) and a receiving baseband digital quadrature signal (RX BD-Q signal 22) into a corresponding receiving data. The TX IQ modulator 16 generates and modulates a transmitting data into a corresponding pair of transmitting baseband digital in-phase signal (TX BD-I signal 24) and transmitting baseband digital quadrature signal (TX BD-Q signal 26). The digital pre-distortion 18 pre-distorts one or both of the amplitude or phase angle of the TX BD-I signal 24 or the TX BD-Q signal 26 into a corresponding pair of pre-distorted TX BD-I signal 28 and pre-distorted TX BD-Q signal 30. The DSP core 12 performs all required arithmetic and control functions in the digital domain. A Digital to Analog Converter (DAC) means 40, in this embodiment two DACs respectively coupled to one output of the DSP 10, for converting the pre-distorted TX BD-I signal 28 and pre-distorted TX BD-Q signal 30 into, following an intervening signal filtering with a transmitting filter means 42, a corresponding pair of baseband analog in-phase signal (BA-I signal 50) and baseband analog quadrature signal (BA-Q signal 52). A transmitting upper sideband mixer (TX USB mixer 60) then up-converts and merges the BA-I signal 50 and BA-Q signal 52 into a transmitting RF-signal 64. The TX USB mixer 60 includes a first local oscillator (LO1 62) of frequency f_{LO1} and the TX USB mixer 60 exhibits, due to its internally generated IQ mismatch, an image rejection ratio (IRR) of IRR₁ typically equal to 20-30 dB. The various components along a receiving signal path of the RFXVR 5 are:

A first programmable receiving mixer (RX mixer-1 74) for down-converting either a receiving RF-signal 72 or the transmitting RF-signal 64 into an Intermediate Frequency signal (IF-signal 76). Correspondingly, a transmitting-to-receiving loop-back switch (TX-RX switch 70) is disposed as shown to allow the switchable coupling of the input of the RX mixer-1 74 to either the receiving RF-signal 72 or the transmitting RF-signal. The RX mixer-1 74 has a second programmable local oscillator (LO2 75) of programmable frequency f_{LO2}. A bandpass filter 78, coupled to the IF-signal 76, passes any in-band signal essentially without an attenuation while attenuates any out-band signal with an attenuation of band pass rejection (BPR) dB thus producing a filtered IF-signal 80. The bandpass filter 78, as shown, is implemented as a surface acoustic wave (SAW) filter and exhibits a pass frequency range from f_{BPI}˜366 MHz to f_{BP2}˜382 MHz with a BPR of at least 40 dB. A second programmable upper sideband/lower sideband receiving mixer (RX USB/LSB mixer-2 90), in combination with a following Analog to Digital Converter (ADC) means 92, function to down-convert and separate the filtered IF-signal 80 into the RX BD-I signal 20 and the RX BD-Q signal 22. The RX USB/LSB mixer-2 90 is capable of operating under either an upper sideband (USB) mode or a lower sideband (LSB) mode. The RX USB/LSB mixer-2 90 has a third programmable local oscillator (LO3 91) of programmable frequency f_{LO3} and the RX USB/LSB mixer-2 90 exhibits an IRR of IRR₂˜20 to 30 dB. As the present invention focuses on a method of correction for IQ mismatch, various details of the RFXVR, which has been disclosed in U.S. patent application Ser. No. 10/447,810 by the same assignee and is herein incorporated by reference, are purposely left out. For example, transmitting power amplifier, antenna and receiving signal amplifier are not shown here.

The present invention is a method by which, rather than attempting to measure the IQ mismatches themselves, one can accurately measure and maximize the image rejection ratio (IRR) of the RFXVR thus indirectly minimizing the IQ mismatches. First, the IRR of the transmitter portion is calculated by measuring the desired transmit sideband and the image transmit sideband using the receiver portion as a demodulator. Here, the measurement can be accurately made despite the presence of IQ mismatches in the receiver portion. This is accomplished by passing the transmitted signal through the bandpass filter 78 along the receiver path and programmably shifting the LO frequencies f_{LO2} and f_{LO3} of the receiver mixers 74 and 90 when measuring the image signal. Hence, this method enables accurate measurement, being made essentially independent of the effect of IQ mismatches in the receiver portion, of both the desired sideband and the image sideband with two separate measurements followed by calculation, using above-mentioned formula (1), of a system image rejection ratio IRR_{sys}. A systematic digital predistortion is then used to adjust the phase and amplitude of the digital baseband modulation signals to maximize the rejection of image signal from the TX USB mixer 60 thus effecting its calibration. After calibration of the TX USB mixer 60, the transmitting signal path can now be used to calibrate the receiving signal path to minimize its IQ mismatches. The reason is that, after the removal of IQ mismatches from the TX USB mixer 60, any subsequently measured IQ mismatches in the transmitter-receiver (TX-RX) loop are now attributable solely to the receiving signal path and can be compensated for accordingly. In this way, IQ mismatches are essentially removed from the RFXVR thereby prevented from impairing the Signal to Noise Ratio (SNR) of modulated signals.

FIG. 3 shows a top-level flow chart of one embodiment of the present invention for calibrating IQ-mismatches of the TX USB mixer 60. The IQ-calibration of TX USB mixer 100 starts with setting initial amplitude & phase of TX BD-I and TX BD-Q signal 110 whereby an initial amplitude and phase value of the TX BD-I signal 24 and the TX BD-Q signal 26 are selected for transmission through the transmitting signal path and the receiving signal path of the RFXVR 5. Next, measure desired transmit sideband with first RFXVR setting 120 measures, using DSP 10, the desired transmit sideband from the RX BD-I signal 20 and the RX BD-Q signal 22. Next, measure image transmit sideband with second RFXVR setting 130 measures, using DSP 10, the image transmit sideband from the RX BD-I signal 20 and the RX BD-Q signal 22. The IRR of the TX USB mixer 60 is then, effectively, calculated by computing IRR_{sys} and store 140. Subsequently, the following two functional blocks:

Adjust amplitude & phase of (TX BD-I, TX BD-Q) using look-up table 150 and look-up table exhausted ? 160,

together with blocks 120, 130 and 140 are iteratively executed throughout a look-up table of pre-determined amplitude and phase adjustments with an IRR of the TX USB mixer 60 effectively computed for each such amplitude and phase adjustment. After the exhaustion of the look-up table, the IQ-calibration of the TX USB mixer 60 is finalized with setting amplitude & phase of (TX BD-I, TX BD-Q) for max. IRR_{sys} 170 whereby a particular amplitude and phase adjustment, corresponding to a maximum value of IRR_{sys}, are selected for future usage by the digital pre-distortion 18. While the embodiment of FIG. 3 uses a look-up table for the amplitude and phase adjustment, for those skilled in the art, numerous other nevertheless equivalent approaches can be employed as well. For example, the amplitude and phase adjustment can be implemented using analytical expressions or heuristic algorithms before their application to the digital pre-distortion 18 to maximize the IRR_{sys}. Other than the above described components of an existing RF transceiver, no additional circuits are needed to implement the present invention. Furthermore, the present invention method circumvents the common problems associated with attempting to characterize IQ-mismatches of high frequency signals by directly measuring the image rejection ratio (IRR_{sys}) of the entire RF transceiver. Therefore, the present invention is robust and insensitive to various circuit parameter mismatches and process variations.

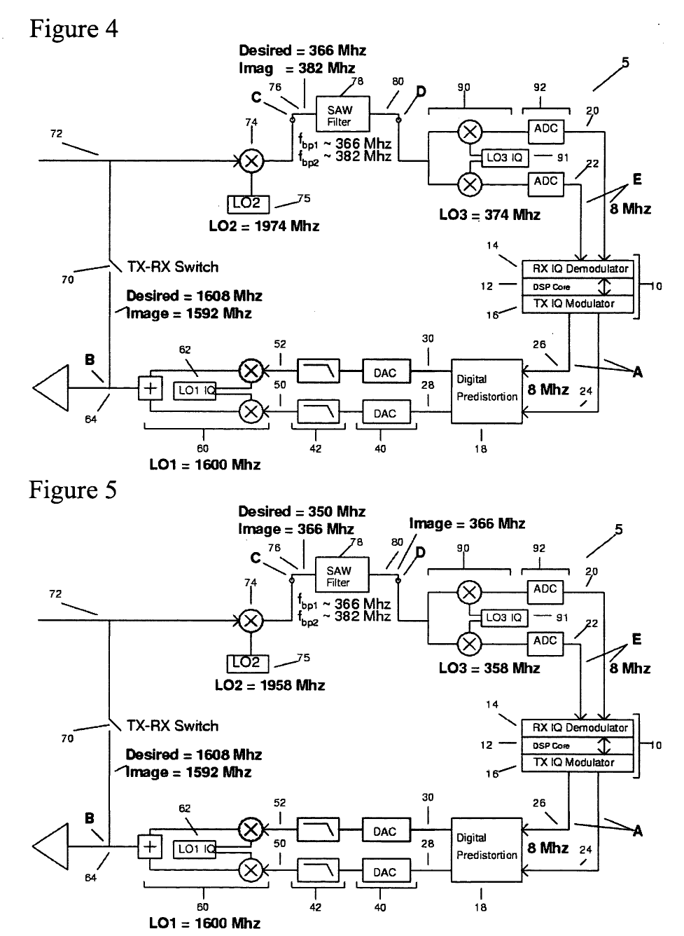

To further elucidate the present invention in more detail, a numerical example of the present invention is illustrated in FIG. 4 through FIG. 5 with further reference to the following description and tables TABLE-1 and TABLE-2 below:

TABLE 1
RF transceiver operating parameters for measuring desired component
signal

| | Desired | Desired | | Image |
|---|---|---|---|---|
| Signal Nodes | Sideband | Sideband | | Sideband |
| of Block | Freq. f_{DSR} | Signal Level | Image Sideband | Signal Level |
| Diagram | (MHz) | S_{DSR} (dB) | Freq. f_{IMG} (MHz) | S_{IMG} (dB) |
| A | 8 | 0 | 8 | 0 |
| B | 1608 | 0 | 1592 | −20 to −30 |
| C | 366 | 0 | 382 | −20 to −30 |
| D | 366 | 0 | 382 | −20 to −30 |
| E | 8 | 0 | 8 | −40 to −60 |

TABLE 2
RF transceiver operating parameters for measuring undesirable image
signal

| | Desired | Desired | | Image |
|---|---|---|---|---|
| Signal Nodes | Sideband | Sideband | | Sideband |
| Block of | Freq. f_{DSR} | Signal Level | Image Sideband | Signal Level |
| Diagram | (MHz) | S_{DSR} (dB) | Freq. f_{IMG} (MHz) | S_{IMG} (dB) |
| A | 8 | 0 | 8 | 0 |
| B | 1608 | 0 | 1592 | −20 to −30 |
| C | 350 | 0 | 366 | −20 to −30 |
| D | 350 | −40 | 366 | −20 to −30 |
| E | 8 | −60 to −70 | 8 | −20 to −30 |

To begin with, the first local oscillator frequency f_{LO1} of the LO1 62 is fixed at 1600 MHz as shown in both FIG. 4 and FIG. 5. FIG. 4 is the simplified RFXVR block diagram with annotations of certain operating parameters for the illustration of the first part of the calibration method for the calibration and correction of IQ mismatches from the TX USB mixer 60 of the RFXVR 5. The calibration and correction of IQ mismatches from the TX USB mixer are as follows:
1. With the DSP 10 generate a transmitting data that is a reference signal S_{REF} at a baseband frequency of f_{REF}=8 MHz, signal node A.
2. Program a first set of RFXVR operating parameters as follows:

Set the RX USB/LSB mixer-2 90 in a first LSB operating mode with the programmable frequency f_{LO3} equal to a first value of f_{LO3-1}=374 MHz

Set the programmable frequency f_{LO2} equal to a first value of f_{LO2-1}=f_{LO1}+f_{LO3-1}=1974 MHz
3. Close the TX-RX switch 70 to couple the transmitting RF-signal 64 to the RX mixer-1 74 thus completing a data path from S_{REF} through the transmitting signal path and the receiving signal path to yield a corresponding demodulated receiving data signal S_{DTA-1} at the DSP 10. Due to IQ mismatches from the TX USB mixer 60 and the RX USB/LSB mixer-2 90, the receiving data signal S_{DTA-1} has a desired component signal S_{DSR-1} at frequency f_{DSR}=8 MHz and an undesirable image signal S_{IMG-1} at frequency f_{IMG}=8 MHz with a corresponding system image rejection ratio IRR_{sys} defined as IRR_{sys}=20×Log₁₀(S_{DSR-1}/S_{IMG-1}). More details of the evolution of the signals S_{DSR} and S_{IMG} follows.
4. After going through the digital pre-distortion 18, the DAC means 40 and the transmitting filter means 42, the 8 MHz reference signal S_{REF} gets up-converted into a transmitting RF-signal 64 at 1608 MHz by the TX USB mixer 60 with a desired component signal frequency=f_{LO1}+f_{REF}=1600+8=1608 MHz. Due to IQ mismatches of the TX USB mixer 60, a second undesirable image signal, referred to as the image signal, will be present with an image frequency=f_{LO1}−f_{REF}=1600−8=1592 MHz. This is node B of FIG. 4. However, the undesirable image signal is now lower than that of the desired component signal level by about 20-30 dB, the typical IRR of the TX USB mixer 60.
5. With the routing of the transmitting RF-signal 64 to the receiving RF-signal 72 through the closed TX-RX switch 70, the RX mixer-I 74 down-converts the receiving RF-signal 72 into the IF-signal 76 using the programmed frequency f_{LO2-1} of 1974 MHz. This is node C of FIG. 4. Here, the desired component signal frequency is equal to f_{LO2-1}−1608=1974−1608=366 MHz but the image signal frequency is equal to f_{LO2-1}−1592=1974−1592=382 MHz.
6. As both desired component signal frequency and image signal frequency are within the pass band, f_{BP1}˜366 MHz to f_{BP2}˜382 MHz of the bandpass filter 78, the two signals pass through the bandpass filter 78 equally into the filtered IF-signal 80 with essentially no attenuation. Therefore, at node D, the image signal is still lower than the desired signal by about 20-30 dB.
7. The filtered IF-signal 80 is now down-converted and separated into the RX BD-I signal 20 and the RX BD-Q signal 22 with the RX USB/LSB mixer-2 90, set in the first LSB operating mode with an f_{LO3-1} of 374 MHz. While both the down-converted desired frequency and the down-converted image frequency are now equal to the original baseband frequency of f_{REF}=8 MHz (374−366=8, 382−374=8), the image signal, at a USB frequency of 382 MHz, has been further rejected with respect to the desired signal at an LSB frequency of 366 MHz by about 20-30 dB, a typical IRR of the RX USB/LSB mixer-2 90. By now the image signal has become about 40-60 dB below the desired signal. This is node E of FIG. 4.
8. In view of the above, after the RX IQ demodulator 14 of DSP 10 demodulates the RX BD-I signal 20 and the RX BD-Q signal 22 into a first demodulated receiving data signal S_{DTA-1} with an undesirable component image signal S_{IMG-1} and a desired component signal S_{DSR-1}, the S_{IMG-1} is attenuated by about 40-60 dB with respect to the S_{DSR-1} and consequently a measured signal power of S_{DTA-1} is essentially equal to that of S_{DSR-1}.

FIG. 5 is the simplified RFXVR block diagram with annotations of certain operating parameters for the illustration of the second part of the calibration method for the calibration and correction of IQ mismatches from the TX USB mixer 60 of the RFXVR 5. The calibration and correction of IQ mismatches from the TX USB mixer are as follows:
9. With the DSP 10 generate a transmitting data that is a reference signal S_{REF} at a baseband frequency of f_{REF}=8 MHz, signal node A.
10. Program a second set of RFXVR operating parameters as follows:

Set the RX USB/LSB mixer-2 90 in a second USB operating mode with the programmable frequency f_{LO3} equal to a second value of f_{LO3-2}=358 MHz, an offset of 16 MHz from f_{LO3-1}=374 MHz.

Set the programmable frequency f_{LO2} equal to a second value of f_{LO2-2}=f_{LO1}+f_{LO3-2}=1958 MHz
11. Close the TX-RX switch 70 to couple the transmitting RF-signal 64 to the RX mixer-1 74 thus completing a data path from S_{REF} through the transmitting signal path and the receiving signal path to yield a corresponding demodulated receiving data signal S_{DTA-2} at the DSP 10. Due to IQ mismatches from the TX USB mixer 60 and the RX USB/LSB mixer-2 90, the receiving data signal S_{DTA-2} has a desired component signal S_{DSR-2} at frequency f_{DSR}=8 MHz and an undesirable image signal S_{IMG-2} at frequency f_{IMG}=8 MHz with a corresponding system image rejection ratio IRR_{sys} defined as IRR_{sys}=20×Log₁₀(S_{DSR-2}/S_{IMG-2}). More details of the evolution of the signals S_{DSR-2} and S_{IMG-2} follows.
12. After going through the digital pre-distortion 18, the DAC means 40 and the transmitting filter means 42, the 8 MHz reference signal S_{REF} gets up-converted into a transmitting RF-signal 64 at 1608 MHz by the TX USB mixer 60 with a desired component signal frequency=f_{LO1}+f_{REF}=1600+8=1608 MHz. Due to IQ mismatches of the TX USB mixer 60, a second undesirable image signal, referred to as the image signal, will be present with an image frequency=f_{LO1}−f_{REF}=1600−8=1592 MHz. This is node B of FIG. 5. However, the undesirable image signal is now lower than that of the desired component signal level by about 20-30 dB, the typical IRR of the TX USB mixer 60.
13. With the routing of the transmitting RF-signal 64 to the receiving RF-signal 72 through the closed TX-RX switch 70, the RX mixer-i 74 down-converts the receiving RF-signal 72 into the IF-signal 76 using the programmed frequency f_{LO2-2} of 1958 MHz. This is node C of FIG. 5. Here, the desired component signal frequency is equal to f_{LO2-2}−1608=1958−1608=350 MHz but the image signal frequency is equal to f_{LO2-2}−1592=1958−1592=366 MHz.
14. As the desired component signal frequency 350 MHz now lies outside while the image signal frequency 366 MHz still stays within the pass band, f_{BP1}−366 MHz to f_{BP2}−382 MHz of the bandpass filter 78, the desired signal gets attenuated by a BPR of at least 40 dB while the image signal passes through the bandpass filter 78 with essentially no attenuation. Recall that, from step 12, the image signal used to be lower than that of the desired signal by about 20-30 dB. Therefore, at node D, the desired signal is now lower than the image signal by at least about 10 to 20 dB.
15. The filtered IF-signal 80 is now down-converted and separated into the RX BD-I signal 20 and the RX BD-Q signal 22 with the RX USB/LSB mixer-2 90, set in the second USB operating mode with an f_{LO3-2} of 358 MHz. While both the down-converted desired frequency and the down-converted image frequency are now equal to the original baseband frequency of f_{REF}=8 MHz (358−350=8, 366−358=8), the desired signal, at an LSB frequency of 350 MHz, has been further rejected with respect to the image signal at a USB frequency of 366 MHz by about 20-30 dB, a typical IRR of the RX USB/LSB mixer-2 90. By now the desired signal has become about 30-50 dB below the image signal. This is node E of FIG. 5.
16. In view of the above, after the RX IQ demodulator 14 of DSP 10 demodulates the RX BD-I signal 20 and the RX BD-Q signal 22 into a second demodulated receiving data signal S_{DTA-2} with an undesirable component image signal S_{IMG-2} and a desired component signal S_{DSR-2}, the S_{DSR-2} is attenuated by about 30-50 dB with respect to the S_{IMG-2} and consequently a measured signal power of S_{DTA-2} is essentially equal to that of S_{IMG-2}.

Now that both the desired component signal S_{DSR} and the undesirable component image signal S_{IMG} have been measured in the above manner, the following steps are used to complete the correction of IQ mismatches from the TX USB mixer 60 of the RFXVR 5:
17. Calculate the system image rejection ratio IRR_{sys} as follows:
   IRR_{sys}=20×Log₁₀(S_{DSR}/S_{IMG})˜20×Log₁₀(S_{DTA-1}/S_{DTA-2}).
18. Systematically adjust, with a look-up table of pre-determined amplitude and phase adjustments and use the digital pre-distortion 18, at least one of the amplitude or phase angle of at least one of the TX BD-I signal 24 or the TX BD-Q signal 26 and each time repeat step-I through step-17 to obtain a new value of IRR_{sys}.
19. Repeat step-18 till the exhaustion of the look-up table, then finalize the IQ-calibration of the TX USB mixer 60 by selecting a particular amplitude and phase adjustment, corresponding to a maximum value of IRR_{sys}, for future usage by the digital pre-distortion 18.
   Notice that the achievable IRR_{sys} is limited by the sum of the BPR of the bandpass filter 78 (about 40 dB) and the IRR of the uncalibrated RX USB/LSB mixer-2 90 (typically about 20-30 dB). Consequently, a correction of the RFXVR IQ mismatch down to a level corresponding to an IRR_{sys} of about 60 dB can be typically realized. Also, on an equivalent basis, a simple ratio k=S_{DTA-1}/S_{DTA-2}, instead of the above IRR_{sys}, can alternatively be maximized to achieve the same result.

After the calibration of the TX USB mixer 60, the following steps are followed to use the now calibrated TX USB mixer 60 to correct IQ mismatches solely from the RX USB/LSB mixer-2 90:
20. With the DSP 10 generate a transmitting data that is a reference signal S_{REF} at a baseband frequency of f_{REF}=8 MHz, signal node A.
21. Program the first set of RFXVR operating parameters like before.
22. Close the TX-RX switch 70 to complete the data path from S_{REF} through the transmitting signal path, now having its IQ mismatch effect from the TX USB mixer 60 minimized, and the receiving signal path to yield a corresponding RX BD-I signal 20 and RX BD-Q signal 22 having, due to IQ mismatches only from the RX USB/LSB mixer-2 90, a mismatch in amplitude ΔA and a mismatch in phase Δφ between them.
23. With the DSP 10, digitally calculate the amplitude mismatch ΔA and the phase mismatch Δφ, digitally correct for ΔA and Δφ accordingly and store the respective corrective values for future correction of IQ mismatch due to the RX USB/LSB mixer-2 90.
24. As step-23 marks the completion of calibration and correction of IQ mismatches of the RFXVR 5, the TX-RX switch 70 should now be opened up to resume normal operation of the RFXVR 5.
   In practice, the calibration method of the present invention can be performed at system power on or periodically during an idle time of the RFXVR 5 to maintain accuracy over time.

In conclusion, this invention provides for a method by which IQ mismatches in an RF transceiver can be calibrated and corrected. The invention uses the existing RF transceiver circuitry to accomplish the task. This is an important attribute of the invention as other approaches typically require additional complicated circuitry and associated large overhead. The novel idea of offsetting the second value of a programmable receiver mixer frequency fLO3 from its first value allows one to use the existing bandpass filter of the RF transceiver to effectively create a near perfect down-converting operation thereby allowing one to attribute essentially all IQ mismatches to the transmitting signal path. Accordingly, this allows one to correct IQ mismatches down to a very low level. After calibration and correction of the transmitter, calibration and correction of the receiver IQ mismatches becomes possible and straightforward. In effect, this invention achieves a fully calibrated RF transceiver using simple, accurate power measurements in the digital domain followed by accurate digital correction. Consequently, various inaccuracies due to IC process variations, device mismatches and layout parasitics are largely reduced with this scheme. By now it should also become clear to those skilled in the art that, the scope of the present invention method does not depend upon numerous hardware details of the RF transceiver as described. For example, while a set of specific signal and LO frequencies are cited in the above embodiments, many other equivalent sets of signal and LO frequencies can be easily identified to achieve similar results and advantages and, as such, are to be considered within the scope of the present invention.

1. A calibration method for correcting amplitude and phase mismatch between in-phase and quadrature signals, called IQ mismatch, in a radio frequency transceiver (RFXVR) having a transmitting path and a receiving path, the method comprising:
a. generating a baseband reference signal S_{REF} at frequency f_{REF} that results in, through the transmitting path, a transmitting RF-signal;
b. coupling said transmitting RF-signal through the receiving path thereby yielding a data signal S_{DTA} having a desired component S_{DSR} at frequency f_{DSR} and an undesired image signal S_{IMG} at frequency f_{IMG}; and
c. iteratively programming the RFXVR until a corresponding ratio k=S_{DSR}/S_{IMG} is maximized thereby minimizing the undesirable effect due to IQ mismatch essentially from a transmitting upper sideband mixer (TX USB mixer) of the transmitting path.

2. The method of claim 1 wherein said ratio k is further expressed in a logarithmic power domain so as to correspond to a system image rejection ratio (IRR) of IRR_{sys}=20×Log₁₀(S_{DSR}/S_{IMG}).

3. The method of claim I wherein step-c further comprises:
c1. programming a first RFXVR setting thereby yielding a first data signal S_{DTA-1} whose undesired image S_{IMG-1} is sufficiently attenuated with respect to whose desired component S_{DSR-1} making the signal power of S_{DSR-1} essentially equal to that of S_{DTA-1};
c2. programming a second RFXVR setting thereby yielding a second data signal S_{DTA-2} whose desired component S_{DSR-2} is sufficiently attenuated with respect to whose undesired image S_{IMG-2} making the signal power of S_{IMG-2} essentially equal to that of S_{DTA-2}; and
c3. repeating step-c1 and step-c2, each time after systematically pre-distorting at least the amplitude or the phase of at least one of pre-distorted transmitting baseband in-phase and quadrature signals (TX BD-I or TX BD-Q) along the transmitting path, until the ratio k=S_{DTA-1}/S_{DTA-2} is maximized.

4. The method of claim 3 wherein the step of programming a first RFXVR setting further comprises the settings:
a second local oscillator (LO2) frequency f_{LO2}, being generated by a first programmable receiving mixer (RX mixer-1) of the receiving path, equal to a first value f_{LO2-1}; and
a second programmable upper sideband/lower sideband receiving mixer (RX USB/LSB mixer-2) in first operating mode generating a third local oscillator (LO3) frequency fLO3 equal to a first value f_{LO3-1}.

5. The method of claim 4 wherein the step of programming a second RFXVR setting further comprises the following settings:
said f_{LO2} equal to a second value f_{LO2-2}; and
said RX USB/LSB mixer-2 in second operating mode generating said f_{LO3} equal to a second value f_{LO3-2}.

6. The method of claim 1 further comprises, after step-c, the following steps to correct IQ mismatch from said RX USB/LSB mixer-2:
d. coupling said transmitting RF-signal to RX mixer-1 thereby yielding corresponding receiving baseband in-phase and quadrature signals (RX BD-I and RX BD-Q) along the receiving path having, due to IQ mismatch only from said RX USB/LSB mixer-2, a mismatch in amplitude ΔA and phase Δφ there between;
e. programming a setting as follows:
said f_{LO2} equal to f_{LO2-1}; and
said RX USB/LSB mixer-2 in first operating mode generating said f_{LO3} equal to f_{LO3-1}; and
f. calculating and correcting for said ΔA and Δφ and storing the respective corrective values for future correction of IQ mismatch due to said RX USB/LSB mixer-2.

7. The method of claim 6 wherein the correction for IQ mismatch is performed at system power on of the RFXVR.

8. The method of claim 7 wherein the correction for IQ mismatch is further performed periodically during idle time of the RFXVR.

9. The method of claim 3 wherein the step of systematically pre-distorting further comprises using a look-up table to set the amplitude and phase angle of at least one of said signals TX BD-I or TX BD-Q.

10. The method of claim 4 wherein said first operating mode is an LSB mode and said second operating mode is a USB mode.

11. The method of claim 1 wherein said receiving path further comprises a bandpass filter, having a pass frequency range from f_{BP1} to f_{BP2}, for passing an in-band Intermediate Frequency (IF) signal while attenuating an out-band IF signal with a band pass rejection (BPR) of dB.

12. The method of claim 11 wherein said BPR is at least about 40 dB.

13. The method of claim 11 wherein said bandpass filter is a SAW (surface acoustic wave) filter.

14. The method of claim 11 wherein said f_{BP1} and f_{BP2}, of said bandpass filter are about 366 MHz and about 382 MHz respectively.

15. The method of claim 1 wherein said TX USB mixer further comprises a first local oscillator (LO1) of frequency f_{LO1} and exhibits an image rejection ratio of IRR₁ dB.

16. The method of claim 15 wherein said f_{LO1} is about 1600 MHz.

17. The method of claim 16 wherein said f_{REF} is about 8 MHz.

18. The method of claim 17 wherein said f_{LO3-1} is about 374 MHz and said f_{LO2-1} is about f_{LO1}+f_{LO3-1}=1974 MHz thereby yielding an S_{DSR-1} at frequency f_{DSR}˜8 MHz and an S_{IMG-1} at frequency f_{IMG}˜8 MHz.

19. The method of claim 4 wherein said RX USB/LSB mixer-2 exhibits an image rejection ratio of IRR₂ dB.

20. The method of claim 19 wherein both said IRR₁ of the TX USB mixer and said IRR₂ of the RX USB/LSB mixer-2 are from about 20 dB to about 30 dB thereby causing said S_{IMG-1} to be about 40 dB to 60 dB below said S_{DSR-1}.

21. The method of claim 17 wherein said f_{LO3-2} is about 358 MHz and said f_{LO2-2} is about f_{LO1}+f_{LO3-2}=1958 MHz thereby yielding an S_{DSR-2} at frequency f_{DSR}˜8 MHz and an S_{IMG-2} at frequency f_{IMG}˜8 MHz.

22. The method of claim 21 wherein both said IRR₁ of the TX USB mixer and said IRR₂ of the RX USB/LSB mixer-2 are from about 20 dB to about 30 dB thereby causing said S_{DSR-2} to be about 30 dB below said S_{IMG-2}.
